(19) United States
(12) Patent Application Publication
(10) Pub. No.: US 2015/0084791 A1
(43) Pub. Date: Mar. 26, 2015

(54) APPARATUS AND METHOD FOR MANAGING SAFETY OF PEDESTRIAN AT CROSSWALK

(71) Applicant: ELECTRONICS AND TELECOMMUNICATIONS RESEARCH INSTITUTE, Daejeon-city (KR)

(72) Inventor: Jeongah JANG, Daejeon (KR)

(21) Appl. No.: 14/493,528

(22) Filed: Sep. 23, 2014

(30) Foreign Application Priority Data
Sep. 23, 2013 (KR) 10-2013-0112609

(51) Int. Cl. G08G 1/005; G08G 1/096

(52) U.S. Cl. CPC G08G 1/005; G08G 1/096
USPC 340/944

(57) ABSTRACT

Disclosed herein are an apparatus and method for managing safety of a pedestrian at a crosswalk, which determine the location of a pedestrian in a crosswalk area, and then selectively provide a pedestrian signal extension service, an approaching vehicle notification service, and a pedestrian danger notification service. A presented apparatus includes a monitoring unit for monitoring a crosswalk area in which a pedestrian waits or crosses a street. A detection unit detects whether a pedestrian is present in the crosswalk area, based on information output from the monitoring unit. A location determination unit determines a location of the pedestrian detected by the detection unit. A safety determination unit determines whether the pedestrian is safe, based on the location of the pedestrian and a state of a pedestrian signal. An information provision unit outputs danger notification information based on a safety/danger determination signal output from the safety determination unit.

### CROSS REFERENCE TO RELATED APPLICATION

This application claims the benefit of Korean Patent Application No. 10-2013-0112609, filed on Sep. 23, 2013, which is hereby incorporated by reference in its entirety into this application.

### BACKGROUND OF THE INVENTION

1. Technical Field

The present invention relates generally to an apparatus and method for managing the safety of a pedestrian at a crosswalk and, more particularly, to an apparatus and method for managing the safety of a pedestrian at a crosswalk, which can manage the safety of a pedestrian present in a crosswalk area.

2. Description of the Related Art

A crosswalk area denotes a space in which a pedestrian waits to cross the street along the route thereof or a space in which a pedestrian crosses the street in compliance with the indication of a pedestrian signal.

Generally, a pedestrian signal at a crosswalk is associated with a vehicle traffic signal, and is implemented such that when the vehicle traffic signal displays a red light, the pedestrian signal is turned on to display a green phase so as to stop the flow of vehicles, thus allowing pedestrians to safely cross the street at the crosswalk.

Such a crosswalk area is an area in which accidents between pedestrians and vehicles occur, and human injury can be severe enough that the vulnerable pedestrians may be injured or killed by vehicular traffic, and thus pedestrians and vehicles must observe their respective traffic signals.

As accidents in the crosswalk area, there are various possibilities that can occur: a case where a vehicle violates a signal, a case where a pedestrian ignores a signal and crosses the street in spite of a red light, and a case where a pedestrian signal displays a green light, but a remaining pedestrian green time is shorter than the time needed for the pedestrian to safely cross the street, thus leading to accidents.

Traffic accidents may occur in the following cases: a case where, when a pedestrian signal displays a red light, a time for which a pedestrian is waiting at the crosswalk is lengthened, a case where, when a pedestrian signal displays a green light, the pedestrian attempts to cross the street ignoring the remaining pedestrian green time, and a case where a green time at a crosswalk is insufficient due to the slow walking speed of vulnerable pedestrians, such as the elderly, children, and the disabled. These traffic accidents may be regarded as problems that may frequency occur even if a crosswalk system is desirably provided.

Meanwhile, various attempts to improve the convenience and safety of pedestrians have been made by indicating that a pedestrian is waiting using push button switch information for pedestrians which is recently widely introduced, or by utilizing a variable system or the like for extending the time of a pedestrian signal.

As related preceding technology, there is technology disclosed in Korean Patent Application Publication No. 10-2012-0095538 (entitled “Traffic signaling method at a crosswalk associated with a traffic light”). This technology is configured to operate in conjunction with a crosswalk in such a way that, when a pedestrian is crossing the street at the crosswalk or when a vehicle approaching the crosswalk is detected, the situation of the crosswalk is reported using images displayed on an electronic display board installed on an access road at the crosswalk while a vehicle traffic light is turned on to display a red light, and when the pedestrian completely crosses the crosswalk, a pedestrian traffic light is switched to display a red light while the vehicle traffic light displays a green light to instruct the vehicle driver to pass through the crosswalk, and in such a way that, when the vehicle having passed through the crosswalk passes by an exit road, such a motion is detected and then the vehicle traffic light blinks a yellow light.

As another preceding technology, there is technology disclosed in Korean Patent No. 0797577 (entitled “Variable system for extending the time of a pedestrian signal”) which can extend a pedestrian signal for vulnerable pedestrians while maintaining a control system operating in conjunction with a traffic light by maintaining the overall signal period at a constant period.

As further preceding technology, there is technology disclosed in Korean Patent Application Publication No. 10-2011-0038438 (entitled “Pedestrian safety management system and method”). This patent presents technology in which a sensor unit for recognizing a pedestrian and a road marker operating in conjunction with the sensor unit are provided at a crosswalk, so that the road maker is switched on/off depending on the presence/non-presence of a pedestrian or the motion of the pedestrian, thus allowing the driver of a vehicle passing by an intersection to easily recognize the motion of a pedestrian who is crossing the street at the crosswalk.

As yet another preceding technology, there is technology disclosed in Korean Patent No. 1041633 (entitled “Pedestrian traffic light equipped with an infrared sensor”) in which an infrared (IR) sensor is additionally installed in a pedestrian traffic light, unlike a typical pedestrian traffic light, so that it is detected whether a person who is crossing the street at a crosswalk is present, and the results of the detection are reported in real time to the driver of a vehicle turning right through an auxiliary traffic light, thus preventing traffic accidents from occurring at the crosswalk.

As still another preceding technology, there is technology disclosed in Korean Patent Application Publication No. 10-2013-0010055 (entitled “Crosswalk using an infrared sensor and a weight detection function”), in which a piezoelectric sensor, an infrared sensor, and an electronic display board are installed, thus preventing accidents from occurring when visually handicapped persons and other pedestrians cross the street at a crosswalk in the daytime and nighttime, and also preventing traffic accidents from occurring due to jaywalking of pedestrians.

As still another preceding technology, there is technology disclosed in Korean Patent No. 0831162 (entitled “Method and system for automatically sensing a pedestrian waiting for a signal at a crosswalk and operating a traffic signal controller”). This patent presents technology which notifies the driver of a traveling vehicle of information about the sensing of a pedestrian waiting for a signal to cross the street at a crosswalk in the forward travel path of the vehicle so that the vehicle can safely drive the vehicle, and which assigns a vehicular traffic priority signal to a traffic signal controller when there is no pedestrian waiting for a signal, so that a smooth traffic flow is provided, thus leading to safer vehicle driving.

### SUMMARY OF THE INVENTION

Accordingly, the present invention has been made keeping in mind the above problems occurring in the prior art, and an object of the present invention is to provide an apparatus and method for managing the safety of a pedestrian at a crosswalk, which determine the location of a pedestrian in a crosswalk area, and then selectively provide a pedestrian signal extension service, an approaching vehicle notification service, and a pedestrian danger notification service for respective dangerous situations of a pedestrian in connection with the time of a pedestrian signal.

In accordance with an aspect of the present invention to accomplish the above object, there is provided an apparatus for managing safety of a pedestrian at a crosswalk, including a monitoring unit for monitoring a crosswalk area in which a pedestrian waits or crosses a street; a detection unit for detecting whether a pedestrian is present in the crosswalk area, based on information output from the monitoring unit; a location determination unit for determining a location of the pedestrian detected by the detection unit; a safety determination unit for determining whether the pedestrian is safe, based on the location of the pedestrian determined by the location determination unit and a state of a pedestrian signal output from a signal controller, the safety determination unit determining whether the pedestrian is safe by calculating a safe crossing time needed for the pedestrian to safely cross a street at the crosswalk from the location of the pedestrian and by comparing the safe crossing time with a remaining pedestrian green time output from the signal controller; and an information provision unit for outputting danger notification information based on a safety/danger determination signal output from the safety determination unit.

Preferably, the safety determination unit may be configured to, when the pedestrian is in a pedestrian waiting space and the pedestrian signal displays a green light, determine that the pedestrian is in danger if the calculated safe crossing time is greater than the remaining pedestrian green time.

Preferably, the safety determination unit may be configured to, when the pedestrian is present in an intra-crosswalk space, determine that the pedestrian is in danger if the safe crossing time based on the location of the pedestrian is greater than the remaining pedestrian green time. In this case, the information provision unit may output information required to notify the pedestrian of a danger, information required to notify an approaching vehicle of a danger, and information required to extend the pedestrian signal, based on the safety/danger determination signal output from the safety determination unit. Further, the information provision unit may provide an additional pedestrian green time to the signal controller when the information required to extend the pedestrian signal is output.

Preferably, the safety determination unit may be configured to, when the pedestrian is present in an additional space other than a pedestrian waiting space and an intra-crosswalk space, determine that the pedestrian is in danger regardless of the safe crossing time and the remaining pedestrian green time. In this case, the information provision unit may output information required to notify the pedestrian of a danger and information required to notify the approaching vehicle of a danger, based on the safety/danger determination signal output from the safety determination unit.

Preferably, the monitoring unit may include one or more laser scanners and cameras.

In accordance with another aspect of the present invention to accomplish the above object, there is provided a method for managing safety of a pedestrian at a crosswalk, including monitoring, by a monitoring unit, a crosswalk area in which a pedestrian waits or crosses a street; detecting, by a detection unit, whether a pedestrian is present in the crosswalk area, based on information obtained at monitoring; determining, by a location determination unit, a location of the pedestrian detected at detecting whether the pedestrian is present; determining, by a safety determination unit, whether the pedestrian is safe, based on the location of the pedestrian determined at determining the location and a state of a pedestrian signal output from a signal controller, wherein determining whether the pedestrian is safe is performed by calculating a safe crossing time needed for the pedestrian to safely cross a street at the crosswalk from the location of the pedestrian and by comparing the safe crossing time with a remaining pedestrian green time output from the signal controller; and outputting, by an information provision unit, danger notification information based on a safety/danger determination signal output at determining whether the pedestrian is safe.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a traffic system to which an apparatus for managing the safety of a pedestrian at a crosswalk according to an embodiment of the present invention is applied;

FIG. 2 is a diagram showing an example in which a laser scanner, a camera, a pedestrian traffic light, and a vehicle traffic light shown in FIG. 1 are installed; and

FIG. 3 is a flowchart showing a method for managing the safety of a pedestrian at a crosswalk according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

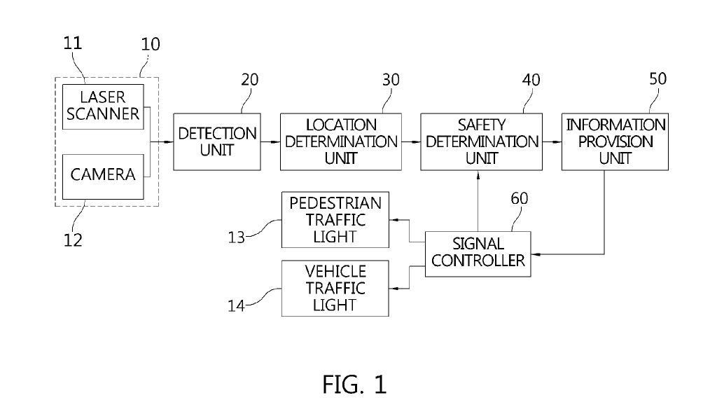

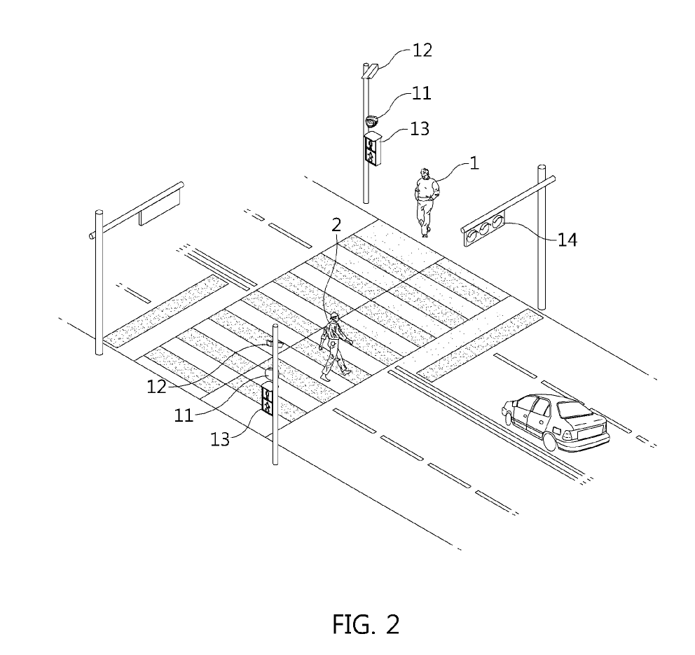

FIG. 1 is a diagram showing the configuration of a traffic system to which an apparatus for managing the safety of a pedestrian at a crosswalk according to an embodiment of the present invention is applied, and FIG. 2 is a diagram showing an example in which a laser scanner, a camera, a pedestrian traffic light, and a vehicle traffic light shown in FIG. 1 are installed.

The configuration of FIG. 1 includes a monitoring unit 10, a pedestrian traffic light 13, a vehicle traffic light 14, a detection unit 20, a location determination unit 30, a safety determination unit 40, an information provision unit 50, and a signal controller 60.

The monitoring unit 10 is installed in a crosswalk area in which a pedestrian waits or crosses the street. The crosswalk area includes a pedestrian waiting space, an intra-crosswalk space, and an additional space. Here, the pedestrian waiting space denotes a space in which the pedestrian waits immediately before the pedestrian enters the crosswalk, the intra-crosswalk space denotes an arbitrary space in the crosswalk, and the additional space denotes the space other than the pedestrian waiting space and the intra-crosswalk space, and refers to a space around the crosswalk (for example, an intersection adjacent to the crosswalk). Therefore, the monitoring unit 10 monitors the pedestrian waiting space, the intra-crosswalk space, and the additional space.

Preferably, the monitoring unit 10 may include one or more laser scanners 11 and one or more cameras 12 at each crosswalk. A plurality of cameras 12 for detecting pedestrians may be installed and a plurality of laser scanners 11 may be installed depending on the size of the crosswalk. The spatial detection sizes and environmental conditions of the laser scanners 11 and the cameras 12 are not limited to specific specifications in such a way that a pedestrian is mainly detected based on the cameras 12 at daytime, and a pedestrian is mainly detected based on the laser scanners 11 at nighttime.

As shown in FIG. 2, the laser scanners 11 and the cameras 12 are installed to be fastened to supports in a footway that is in contact with the crosswalk. Preferably, the laser scanners 11 and the cameras 12 may be installed to face the pedestrian waiting space, the intra-crosswalk space, and the additional space so as to perform monitoring.

The pedestrian traffic light 13 is installed near the crosswalk (see FIG. 2), and displays a pedestrian signal (for example, green or red) that may be identified by the pedestrian with naked eyes. Of course, the pedestrian traffic light 13 may also display the remaining pedestrian green time. Further, the pedestrian traffic light 13 may also perform a blinking operation indicating that a time at which the pedestrian signal will be changed from a green light to a red light is near.

The vehicle traffic light 14 is installed near the crosswalk (see FIG. 2) and displays a traffic signal (for example, green, red, or yellow) that may be identified with naked eyes by the driver of a vehicle traveling through an intersection.

The detection unit 20 determines whether a pedestrian is present in the crosswalk area, based on information monitored by the monitoring unit 10. That is, the detection unit 20 may detect whether a pedestrian is present or not in the crosswalk area, based on the information from the monitoring unit 10, and may detect the waiting state and crossing state of the pedestrian. Here, a method of detecting a pedestrian may be easily and sufficiently understood by those skilled in the art from well-known technology, and thus a detailed description thereof will be omitted here.

In FIG. 1, although the monitoring unit 10 and the detection unit 20 are shown as separate components, it is possible to represent the monitoring unit 10 and the detection unit 20 as a single module.

The location determination unit 30 detects the location of the pedestrian detected by the detection unit 20. That is, the location determination unit 30 may determine whether the pedestrian is currently located in the pedestrian waiting space, the intra-crosswalk space, or the additional space. In FIG. 1, a pedestrian 1 is located in the pedestrian waiting space, and a pedestrian 2 is located in the intra-crosswalk space. In order to estimate the location of each pedestrian, information about a node, a link, and coordinates of the corresponding area having the form of a map may be used, or the relative coordinate systems of the area may be used, but location estimation is not limited to specific specifications. The location estimation of the pedestrian may be easily and sufficiently understood by those skilled in the art from well-known technology, and thus a detailed description thereof will be omitted.

The safety determination unit 40 determines whether the corresponding pedestrian is safe, based on the location of the pedestrian determined by the location determination unit 30 and the state of a pedestrian signal output from the signal controller 60. That is, the safety determination unit 40 is configured to, when the location of the pedestrian has been determined by the location determination unit 30, determine whether the pedestrian is safe, depending on the state of the pedestrian signal output from the signal controller 60. In particular, the safety determination unit 40 calculates a safe crossing time for which the pedestrian can safely cross the street at the crosswalk from the current location of the pedestrian, compares the calculated safe crossing time with a remaining pedestrian green time output from the signal controller 60, and thus determines whether the pedestrian is safe. Here, the safe crossing time may be represented by the equation “safe crossing time (s)=crosswalk width (m)/walking speed (m/s)”. The walking speed may be implemented using various values such as the average walking speed of pedestrians passing by the installation area of the crosswalk, a value corresponding to 85% of walking speeds, a walking speed value for the type of each pedestrian (the elderly, children, the disabled, etc.), or an average walking speed estimated by the laser scanners 11 and the cameras 12. The walking speed is not limited to any one specific value exemplified in the above example, and may be differently applied to and used in individual installation areas. Further, the width of the crosswalk may be preset for individual areas in which crosswalks are installed.

Based on a safety/danger determination signal output from the safety determination unit 40, the information provision unit 50 outputs danger notification information corresponding to the safety/danger determination signal. In greater detail, the information provision unit 50 may output one or more of information required to notify a pedestrian of the danger, information required to notify an approaching vehicle of the danger, and information required to extend a pedestrian signal, based on the safety/danger determination signal output from the safety determination unit.

The present invention monitors the situation of each pedestrian in real time, and provides customized information based on the location of the pedestrian and a pedestrian signal. The form of the provision of such customized information is exemplified in the following Table 1.

TABLE 1

| | | | Pedestrian signal | |
|---|---|---|---|---|
| | | Provision of danger | extension | Provision of danger |
| | | notification to | (in conjunction with | notification to |
| Type | Pedestrian location | pedestrian | signal controller) | approaching vehicle |
| 1 | Waiting space | Performed | — | — |
| 2 | Intra-crosswalk | Performed | Performed | Performed |
| | space | | | |
| 3 | Additional space | Performed | — | Performed |

That is, the safety determination unit 40 is configured to, if it is determined that the calculated safe crossing time is greater than the remaining pedestrian green time in a state in which a pedestrian is present in the pedestrian waiting space and a pedestrian signal displays a green light, determine that the pedestrian is in danger and send a safety/danger determination signal corresponding to such a situation to the information provision unit 50. Accordingly, the information provision unit 50 outputs information required to notify the pedestrian of the danger based on the safety/danger determination signal output from the safety determination unit 40.

Meanwhile, the safety determination unit 40 is configured to, if the safe crossing time of the pedestrian based on the location of the pedestrian is greater than the remaining pedestrian green time when the pedestrian is present in the intra-crosswalk space, determine that the pedestrian is in danger, and send a safety/danger determination signal corresponding to such a situation to the information provision unit 50. Accordingly, the information provision unit 50 outputs information required to notify the pedestrian of the danger, information required to notify the approaching vehicle of the danger, and information extending the pedestrian signal, based on the safety/danger determination signal output from the safety determination unit 40. Here, upon outputting the information required to extend the pedestrian signal, the information provision unit 50 provides an additional pedestrian green time to the signal controller 60.

Meanwhile, the safety determination unit 40 is configured to, when the pedestrian is present in the additional space, determine that the pedestrian is in danger regardless of the safe crossing time and the remaining pedestrian green time, and send a safety/danger determination signal corresponding to this situation to the information provision unit 50. Accordingly, the information provision unit 50 outputs information required to notify the pedestrian of the danger and information required to notify the approaching vehicle of the danger, based on the safety/danger determination signal output from the safety determination unit 40.

In FIG. 1, the signal controller 60 controls the signal periods of the pedestrian traffic light 13 and the vehicle traffic light 14.

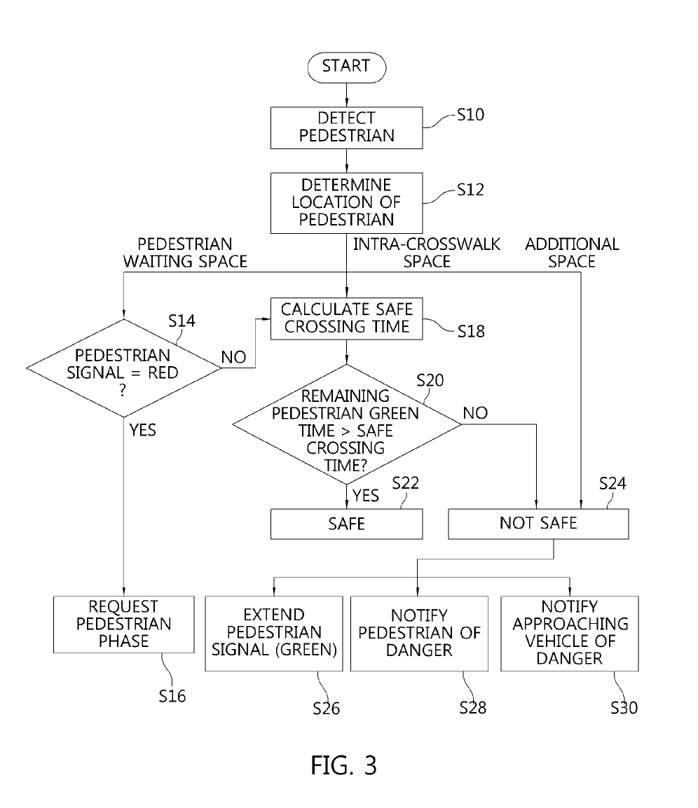

Below, a method of managing the safety of a pedestrian at a crosswalk according to an embodiment of the present invention will be described in detail with reference to the flowchart of FIG. 3.

At step S10, one or more laser scanners 11 and one or more cameras 12 are operated to continuously monitor a crosswalk area. If a pedestrian is moving and appears in a detection area, the detection unit 20 detects the presence or non-presence of the pedestrian. In this case, if several pedestrians are present, the detection unit 20 detects the presence of individual pedestrians.

At step S12, the location determination unit 30 determines the locations of respective objects corresponding to the detected pedestrians. In this case, the location determination unit 30 divides the locations of pedestrians into a pedestrian waiting space, an intra-crosswalk space, and an additional space. Here, the pedestrian waiting space and the additional space are classified as the concept of a walking safety section based on a physical crosswalk, and are arbitrarily set by an operator in consideration of the shape of a physical road.

Thereafter, it is determined whether the corresponding pedestrian is safe, depending on the location of the pedestrian and the state of a pedestrian signal, and then customized information is provided.

First, when the pedestrian is detected and is present in the pedestrian waiting space, the safety determination unit 40 determines whether a pedestrian signal determined by the signal controller 60 displays a red light at step S14.

As a result, if it is determined that the pedestrian signal displays a red light, the process proceeds to step S16 where the safety determination unit 40 requests the signal controller 60 to perform a pedestrian phase in the signal period of the signal controller 60 in a green light through the information provision unit 50. By means of this, the pedestrian does not need to wait for a long period of time and may automatically make a pedestrian signal request without pressing a pedestrian push button.

Meanwhile, in a situation in which the pedestrian is present in the pedestrian waiting space, when a pedestrian signal displays a green light, the process proceeds to step S18 where the safety determination unit 40 calculates a safe crossing time.

Thereafter, at step S20, the safety determination unit 40 compares the calculated safe crossing time with a remaining pedestrian green time currently received from the signal controller 60.

If the remaining pedestrian green time is greater than the safe crossing time, the pedestrian may cross the street at the crosswalk at step S22.

However, if the remaining pedestrian green time is not greater than the safe crossing time, the safety determination unit 40 determines that the pedestrian is not safe at step S24. Accordingly, the safety determination unit 40 sends a signal corresponding to such determination results to the information provision unit 50. In this way, if it is determined that the pedestrian has been detected in the pedestrian waiting space, and it is not safe for the pedestrian to cross the street at the crosswalk from a current time, the information provision unit 50 provides a warning or notification of a pedestrian danger so that the pedestrian does not enter the crosswalk, based on the safety/danger determination signal output from the safety determination unit 40 at step S28. In this case, a method of providing a warning or notification of a pedestrian danger may be implemented in various forms such as using an electronic display board, a sound, a smart phone, or an exclusive terminal. In this case, the pedestrian remains in the pedestrian waiting space without crossing the street at the crosswalk, the function of extending a pedestrian signal and notifying the approaching vehicle of the danger is not performed. As an example, even if a method of providing a warning or notification of a pedestrian danger using an electronic display board, a sound, a smart phone or an exclusive terminal, as in the above example, is not described in greater detail, it may be sufficiently understood by those skilled in the art from well-known technology.

Second, if a pedestrian is detected and is present in the intra-crosswalk space, the safety determination unit 40 calculates a safe crossing time based on the location of the pedestrian, and compares the safe crossing time with a remaining pedestrian green time output from the signal controller 60. Here, even if the pedestrian signal displays a red light, the remaining pedestrian green time is ‘0’, and thus this procedure is performed without change.

If the remaining pedestrian green time is greater than the safe crossing time, the pedestrian may safely cross the street at the crosswalk.

However, if the remaining pedestrian green time is not greater than the safe crossing time, the problem of safety may arise when the pedestrian crosses the street at the crosswalk. Thus, the information provision unit 50 performs pedestrian danger notification step S28, pedestrian signal extension step S26, and the approaching vehicle danger notification step S30 of notifying an approaching vehicle of the danger, based on the safety/danger determination signal output from the safety determination unit 40. Here, the extension of the pedestrian signal denotes a method of additionally providing a pedestrian green time in conjunction with the signal controller 60. That is, the information provision unit 50 provides an additional pedestrian green time to the signal controller 60 when outputting information required to extend the pedestrian signal. In this case, the additional time is limited to a maximum extendable time for the pedestrian green time to such an extent that the flow of vehicle traffic is not greatly interfered with (for example, a preset time or a time adjustable according to the traffic flow), and a green time extension service is provided by operating in conjunction with the information of the signal controller 60 and the information of signal controllers for all vehicles and a signal controller at an intersection. Further, in the case of the approaching vehicle danger notification, the vehicles and the information provision unit 50 use a Vehicle-to-Infrastructure (V2I) communication. That is, the information provision unit 50 performs a Vehicle-to-Pedestrian (V2P) service for immediately providing danger notification information to a terminal mounted in a vehicle or a smart phone via the V2I communication. Here, the V2I communication schemes may be implemented using various communication methods such as local communication or backbone network communication, for example, Wireless Access in Vehicular Environments (WAVE), Wireless Local Area Network (WLAN), or Long-Term Evolution (LTE) communication, and are not limited to specific communication methods. Although a detailed description of the above-described V2I communication is not separately made, it may be sufficiently understood by those skilled in the art from well-known technology.

Third, if a pedestrian is detected and is present in the additional space, there will be a big problem due to jaywalking or the accidental incident of the pedestrian. Accordingly, the information provision unit 50 performs the step S28 of notifying the pedestrian of the danger and the step S30 of notifying an approaching vehicle of the danger based on the safety/danger determination signal output from the safety determination unit 40. The third case described here corresponds to a case where the pedestrian is present in the additional space regardless of whether the pedestrian signal displays a green or red light.

In accordance with the present invention having the above configuration, a pedestrian is automatically detected using information obtained by laser scanners and cameras at a crosswalk, and the location of the pedestrian is determined, so that it is determined whether the pedestrian is in danger in conjunction with the information of a signal controller, and the results of determination may be provided to the pedestrian, a vehicle, etc.

In order to improve the safety of a pedestrian at a crosswalk, a pedestrian signal may be automatically extended in consideration of a safe crossing time depending on the location of the pedestrian and the state of a traffic signal. Further, in the case of a dangerous situation, danger notification information may be provided to the pedestrian and a vehicle, thus preventing accidents from occurring at the crosswalk.

Additionally, the situation of a pedestrian is monitored in real time, thus enabling the present invention to be utilized for the prevention of accidents and immediate processing after the occurrence of accidents from the standpoint of road operators.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for managing safety of a pedestrian at a crosswalk, comprising:
a monitoring unit for monitoring a crosswalk area in which a pedestrian waits or crosses a street;
a detection unit for detecting whether a pedestrian is present in the crosswalk area, based on information output from the monitoring unit;
a location determination unit for determining a location of the pedestrian detected by the detection unit;
a safety determination unit for determining whether the pedestrian is safe, based on the location of the pedestrian determined by the location determination unit and a state of a pedestrian signal output from a signal controller, the safety determination unit determining whether the pedestrian is safe by calculating a safe crossing time needed for the pedestrian to safely cross a street at the crosswalk from the location of the pedestrian and by comparing the safe crossing time with a remaining pedestrian green time output from the signal controller; and
an information provision unit for outputting danger notification information based on a safety/danger determination signal output from the safety determination unit.

2. The apparatus of claim 1, wherein the safety determination unit is configured to, when the pedestrian is in a pedestrian waiting space and the pedestrian signal displays a green light, determine that the pedestrian is in danger if the calculated safe crossing time is greater than the remaining pedestrian green time.

3. The apparatus of claim 2, wherein the information provision unit outputs information required to notify the pedestrian of a danger, based on the safety/danger determination signal output from the safety determination unit.

4. The apparatus of claim 1, wherein the safety determination unit is configured to, when the pedestrian is in an intra-crosswalk space, determine that the pedestrian is in danger if the safe crossing time based on the location of the pedestrian is greater than the remaining pedestrian green time.

5. The apparatus of claim 4, wherein the information provision unit outputs information required to notify the pedestrian of a danger, information required to notify an approaching vehicle of a danger, and information required to extend the pedestrian signal, based on the safety/danger determination signal output from the safety determination unit.

6. The apparatus of claim 5, wherein the information provision unit provides an additional pedestrian green time to the signal controller when the information required to extend the pedestrian signal is output.

7. The apparatus of claim 1, wherein the safety determination unit is configured to, when the pedestrian is present in an additional space other than a pedestrian waiting space and an intra-crosswalk space, determine that the pedestrian is in danger regardless of the safe crossing time and the remaining pedestrian green time.

8. The apparatus of claim 7, wherein the information provision unit outputs information required to notify the pedestrian of a danger and information required to notify the approaching vehicle of a danger, based on the safety/danger determination signal output from the safety determination unit.

9. The apparatus of claim 1, wherein the monitoring unit comprises one or more laser scanners and cameras.

10. A method for managing safety of a pedestrian at a crosswalk, comprising:
monitoring, by a monitoring unit, a crosswalk area in which a pedestrian waits or crosses a street;
detecting, by a detection unit, whether a pedestrian is present in the crosswalk area, based on information obtained at monitoring;
determining, by a location determination unit, a location of the pedestrian detected at detecting whether the pedestrian is present;
determining, by a safety determination unit, whether the pedestrian is safe, based on the location of the pedestrian determined at determining the location and a state of a pedestrian signal output from a signal controller, wherein determining whether the pedestrian is safe is performed by calculating a safe crossing time needed for the pedestrian to safely cross a street at the crosswalk from the location of the pedestrian and by comparing the safe crossing time with a remaining pedestrian green time output from the signal controller; and
outputting, by an information provision unit, danger notification information based on a safety/danger determination signal output at determining whether the pedestrian is safe.

11. The method of claim 10, wherein determining whether the pedestrian is safe is configured to, when the pedestrian is in a pedestrian waiting space and the pedestrian signal displays a green light, determine that the pedestrian is in danger if the calculated safe crossing time is greater than the remaining pedestrian green time.

12. The method of claim 11, wherein outputting the danger notification information is configured to output information required to notify the pedestrian of a danger, based on the safety/danger determination signal output at determining whether the pedestrian is safe.

13. The method of claim 10, wherein determining whether the pedestrian is safe is configured to, when the pedestrian is in an intra-crosswalk space, determine that the pedestrian is in danger if the safe crossing time based on the location of the pedestrian is greater than the remaining pedestrian green time.

14. The method of claim 13, wherein outputting the danger notification information is configured to output information required to notify the pedestrian of a danger, information required to notify an approaching vehicle of a danger, and information required to extend the pedestrian signal, based on the safety/danger determination signal output at determining whether the pedestrian is safe.

15. The method of claim 14, wherein outputting the danger notification information is configured to provide an additional pedestrian green time to the signal controller when the information required to extend the pedestrian signal is output.

16. The method of claim 10, wherein determining whether the pedestrian is safe is configured to, when the pedestrian is present in an additional space other than a pedestrian waiting space and an intra-crosswalk space, determine that the pedestrian is in danger regardless of the safe crossing time and the remaining pedestrian green time.

17. The method of claim 16, wherein outputting the danger notification information is configured to output information required to notify the pedestrian of a danger and information required to notify the approaching vehicle of a danger, based on the safety/danger determination signal output at determining whether the pedestrian is safe.
